(19) United States
(12) Patent Application Publication
(10) Pub. No.: US 2012/0131730 A1
(43) Pub. Date: May 31, 2012

(54) Contoured Face Shields and Method of Producing Optically Clear Parts

(76) Inventors: Gilad Shoham, Toronto (CA); Philip Joseph Wilcox, Toronto (CA)

(21) Appl. No.: 12/672,654

(22) PCT Filed: Aug. 8, 2008
(86) PCT No.: PCT/US08/72708

§ 371 Date: Feb. 15, 2012

Related U.S. Application Data
(60) Provisional application No. 60/964,210, filed on Aug. 10, 2007.

(51) Int. Cl. A41D 13/11; B29D 11/00; B29C 35/00; A41D 13/015

(52) U.S. Cl. 2/411; 2/9; 2/421; 264/2.7; 425/143

(57) ABSTRACT

A face shield comprising a contoured visor with three-dimensional structures with varying angles along multiple axes for improved protection and user comfort, an adjustable attachment member for easy user adjustment, and head contact area with improved ventilation. Methods of producing optically clear three-dimensional plastic structures with varying angles along multiple axes and tools for said method.

### CROSS-REFERENCE

This application claims the benefit of U.S. Provisional Application No. 60/964,210 filed Aug. 10, 2007 and U.S. Provisional Application entitled Method of Producing Optically Clear Thermoformed Parts Using Selective Thermal Masking filed Jul. 14, 2008. The contents of both provisional applications are incorporated herein by reference in their entirety.

### BACKGROUND OF THE INVENTION

Disposable Face Shields are a type of Personal Protective Equipment (PPE) typically used in healthcare environments by clinicians, such as doctors and nurses. In the course of routine patient care, clinicians may be exposed to dangerous droplet-borne pathogens, such as those carried in a cough, sneeze, or other accidental aerosolized body fluid of an infected patient. These pathogens may be quite dangerous, and represent a high risk to clinicians as well as other patients. Face shields help significantly protect the wearer by covering vulnerable orifices, such as the eyes, nose, and mouth, from potential droplet contamination.

There are several face shield variants currently available on the market, but they share a number of common, important limitations. Existing face shields are primarily made up of a flat, “rolled” sheet of optically clear plastic (a “visor”), which is bent into a generally cylindrical shape when worn. This geometry presents a systemic limitation, because clinicians tend to stand while caring for bed-bound patients. In this most-common patient/clinician configuration, the patient is physically located well below the clinician, but the rolled sheet design offers little or no protection from potential contaminants coming from below, unless the clinician is tilting their heads straight down.

Current makers of face shields have attempted to address limitations associated with insufficient bottom-portion coverage by extending the visor below the chin as far as is practical, thereby improving lower-face coverage. However, this seriously compromises usability. When the wearer tilts their head downwards to look directly at their bed-bound patient, they risk dislodging the mask simply by contact of the visor with their chest or neck, further reducing its effectiveness. The large amount of visor material below and to the sides of the jaw are also at great risk of being dislodged when the wearer performs typical actions such as moving their heads from side to side, or reaching an arm across their body, such as to adjust a knob or pick up an item.

However, due to the well established difficulty in achieving high level of optical clarity after a thermoforming process, modifying the general structure of face shields is difficult. It is typically observed that once an optically clear film is heated to its forming temperature, the surface flatness of the film degrades, and the optical clarity degrades significantly.

While the light transmission ability of the material remains generally unchanged, images may appear fuzzy, distorted, uneven, or may have other optical aberrations that make their use as eyewear impractical. This problem becomes especially important when it is desired to manufacture a contoured, disposable face shield.

Accordingly, there remains a need for face shields that avoid the above-mentioned limitations.

### SUMMARY OF THE INVENTION

Provided herein is a face shield that addresses the problems encountered with the current face shields. Also provided herein is a process of making the face shields so as to avoid the present problems. In certain embodiments, the process also may be applied to produce 3-dimensional parts with varying angles along multiple axes with optical clear sections for different uses, including but not limited to disposable glasses, potentially disposable camera optical protection, computer monitor or display covers, and any other applications where a thermoformed part requires a high level of optical performance. It should be noted however, that while some embodiments described herein involve a 3-dimensional configuration with varying angles along multiple axes; it is contemplated herein that other embodiments within the scope of the present application do not required that the 3-dimensional with varying angles along multiple axes.

One embodiment provides a face shield that is curved about multiple axes, thereby providing far improved coverage and protection from patient generated airborne droplets. As a result of this change from a cylindrical shape to a shape with varying angles along multiple axes, the wearer's head is protected from the sides as well as the bottom, significantly enhancing operational safety and user comfort. Furthermore, the varying angles along multiple axes allows better user comfort by allowing the wearer to move their head downwards to look directly at their bed-bound patient, without the risk of dislodging the mask simply by contact of the visor with their chest or neck. Moreover, the wearer has a better user experience in moving their heads from side to side, or reaching an arm across their body, such as to adjust a knob or pick up an item, without the risk of dislodged the mask.

In one embodiment, the face shield geometry is designed such that the flexibility in the visor material allows the face shield to conform to various users' head shapes, while utilizing the strength of the visor material to provide adequate structure and keep it sufficiently off the users' head. Furthermore, the face shield may be worn with or without various facial masks, glasses, goggles, varying hairstyles, and other user preferences.

In one embodiment, the visor is formed of plastic material with excellent optical clarity and light weight. Acceptable plastic material in this embodiment includes, but is not limited to, PET, polycarbonate, polypropylene, OPS, BOP, PVC, polyester, acrylics, polystyrene, rigid vinyl (RPVC) polyester, polyethylene, clear acetate plastic, ABS, and other chemistries. The visor may further comprise a chemical coating on the surface, such as a scratch resistant coating, a tint coating, an anti-fogging coating, a stain-proof coating, and a UV light filtering or blocking coating.

The face mask further comprises an adjustable attachment member for positioning the face shield over the face of the wearer and adapted to adjust the angular position of the face shield relative to the face of the wearer. The strap locations on the back of the head and on the front of the forehead is adjustable such that moving the strap to different places moves the face shield to different angular positions relative to the face of the wearer.

In certain embodiments, the visor band is formed of an elastic material. Acceptable elastic materials in this embodiment include, without limitation, polyisoprene, silicone, natural rubber, chloroprene, nylon, nitrile, polyacrylate, urethane, and styrene butadiene.

The face shield further allows for improved ventilation to minimize fogging of the face shield, thus improving user experience. In one embodiment, the face shield comprises a “tripod” head contact area, which allows for ventilation space to be present between the face shield and contact area of the user. In other embodiments, further ventilation is provided by additional vents on the surface of the visor.

In one embodiment, the tripod is created by deforming the visor material to create the protrusion. In another embodiment, the tripod comprises a separate cushion member such as a cushion material that is attached to the visor by adhesive, by mechanical attachment, or by other attachment such as laser or ultrasonic welding. Acceptable tripod material in this embodiment includes, but is not limited to, foam, gel pad, silicone, urethane, or other polymer or fabric with acceptable skin contact.

Another embodiment further provides a manufacturing technique that allows a part to be manufactured using a thermoforming process while retaining the optical clarity of the original, pre-formed film of suitable material. Furthermore, embodiments are provided that are adaptable for high-speed economical thermoforming production. The following embodiments allow for very fine control over the exact shape and size of the area of optical clarity, allowing for fine design and manufacturing control.

In certain embodiments, the manufacturing method achieves an optically clear viewing surface in a part requiring 3-dimensional geometry with varying angles along multiple axes. In one embodiment, the viewing surface is manufactured by thermal film forming techniques. In this embodiment, the process of thermoforming comprises converting a flat film of plastic into a 3-dimensional part by heating the plastic beyond its forming temperature, then forming the part to its desired shape by draping the film into or onto a mold by gravity, pressure, vacuum, or other force. This 3-dimensional part forming achieves geometric features that enhance product function, such as bosses, ribs, and other 3-dimensional surfaces.

In certain embodiments, the thermoforming process involves heating the film only in areas where 3-dimensional formed geometry is desired, while not heating the film in areas where high optical clarity is desired, thereby selectively controlling the areas that may experience degradation of optical characteristics. In these embodiments, the film areas that are exposed to heat are readily thermoformable, and able to achieve 3-dimensional geometry with varying angles along multiple axes. The areas of film that are masked from heat are not truly thermoformable, because the film material has not become “stretchy” or pliable. These heat-masked “optical” areas are still able to be bent and curved to achieve surface geometries that do not involve stretching of the material such as cylindrical sections or substantially flat sections, but cannot achieve surface geometry with varying angles along multiple axes that would require a fully plastic, elastic surface. In addition, this method may be used with many different types of thermal forming processes, such as vacuum-forming, pressure forming, combination vacuum/pressure forming, and other thermal film forming techniques.

The thermoforming process may involve a vacuum-forming process, wherein a sheet of plastic film is located adjacent to a heating element, allowed to heat up to its forming temperature, at which point it becomes flexible. In this embodiment, the plastic film would be shielded from the heating elements in those select certain sections where optical clarity was desired. The sheet is then draped over a shaped mould, which incorporates a vacuum, drawing the flexible plastic sheet down onto the mould, taking its shape. Once the film cools, it regains its rigidity, only now having the form of the mould.

In another embodiment, the method comprises a pressure-forming process, wherein a sheet of plastic film is brought into contact with a “hot plate”, whereupon the plastic film quickly rises to its forming temperature. When the plastic film reaches the forming temperature, air is blown such as through perforations in the hot plate, pressurizing the film and pressing it against a mould positioned directly in line with the plastic film, where it rapidly cools and hardens to its new shape. In this embodiment, the hot plate may be modified to incorporate the heat mask in a number of different ways. In one embodiment, the heat mask is incorporated by applying an insulation material directly onto the hot plate and attaching it mechanically, magnetically, or by adhesive.

In general, this method may be applied to production processes that occur at a wide range of speeds, such as one-at-a-time production, all the way through to high-speed, automated, in-line thermoforming machinery using high cavitation moulds.

This process may be used for a wide variety of applications, including but not limited to disposable glasses, potentially disposable camera optical protection, computer monitor or display covers, and any other instance where a thermoformed part requires a high level of optical performance.

### BRIEF DESCRIPTION OF THE DRAWINGS

The features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a cross-sectional view of one embodiment wherein the shield comprises a visor with a complex 3-dimensional contour shape (1), a thermoformed 3-dimensional feature with varying angles along multiple axes (3), and improved protection against hazardous matter from below (2).

FIG. 2 is a perspective view of one embodiment wherein the shield comprises a visor with a thermoformed 3-dimensional feature with varying angles along multiple axes (3) for better protection near the chin, and a cylindrical contour shape for the side shields (5).

FIG. 3 is a perspective view of one embodiment wherein the shield comprises a thin, lightweight plastic visor with a complex 3-dimensional contour shape (1), tripod contact area (4), single elastic head strap (6) that is attached to the visor on or near the tripod contact area, and other eye wear simultaneously used by the wearer (7).

FIG. 4 is a perspective view of one embodiment wherein the face shield comprises a tripod contact area (4), elastic head strap (6) that is attached to the visor on or near the tripod contact area, adjustability of the head strap behind the user's head (8), and adjustability of the visor angle with respect to the user's face (9).

FIG. 5 is a perspective view of one embodiment wherein the face shield comprises a tripod contact area (2) and ventilation as shown by (10) and (11) for fog management.

FIG. 6 is a perspective view of one embodiment wherein the face shield comprises a visor with a complex 3-dimensional contour shape (1) and tripod contact area (4) comprising a protrusion made by thermoforming of the visor, wherein said face shield is on its side for stacking.

FIG. 7 is a perspective view of one embodiment wherein the face shield is stacked (12) inside a box (13).

FIG. 8 is a perspective view of one embodiment of forming the plastic film into a shape with varying angles along multiple axes while maintaining optical clarity in certain designated areas of the plastic film, wherein the apparatus comprises a mould mounting plate (14), mould and die sets (15), custom hot-plate with embedded cutting and embedded insulation surface (16), and heating surface (17). In certain embodiments, the mould mounting plate (14) is steel, the mould and die sets (15) are each mounted to a block fastened to mounting plate through slots, allowing for 1-axis adjustment, and custom hot-plate (16) is aluminum and connected to the hot plate (17).

FIG. 9 is a top view of the custom hot plate with embedded cutting and embedded insulation surface as shown in FIG. 8 (16) comprising an inlaid hardened strike plate (18), optionally back-connected to aluminum and approximately ½ inch to ¾ inch thick, inlaid thermal insulator (19), optionally back-connected to the strike plates or to the aluminum hotplate, optionally with air holes, aluminum hotplate (20), connected to heating element, and cutting area (21), optionally with extra strike-plate area to allow for adjusting mold cutter position. FIG. 9 also provides a side view of the same custom hot plate (16) embodying the strike plate (18), thermal insulator (19), and aluminum hotplate (20).

FIG. 10 is a closer side view detail of one embodiment of forming the plastic film into a shape with varying angles along multiple axes while maintaining optical clarity in certain designated areas of the plastic film, wherein the apparatus comprises a steel mould mounting plate (14) affixed with slots, mould assembly (15) comprising a mould and cutting dies bottom-connected to custom cavity plate (23), which in turn is connected to said mounting plate through slots allowing each cavity some position adjustment in one axis as shown by (22), by shifting the position of the cavity assembly via bolts in slots in the mounting plate, and custom hotplate (16).

### DETAILED DESCRIPTION OF THE INVENTION

Provided herein is a face shield, a type of device that provides protection to the wearer's face from various hazards, which addresses the problems under the current face shields. Face shields in certain embodiments comprise a visor and a member for engaging and positioning the visor onto the wearer's face. In these embodiments, the visor comprises a thin semi-rigid body member, such as a plastic film, that functions as the protective shield against the hazardous matters. The member for engaging and positioning the visor can comprise various combinations. In one embodiment, the member comprises a head contacting member, such as a cushion member that makes contact with the user's forehead. In another embodiment, the member comprises a head engaging member, such as an elastic strap that wraps around the user's head. In yet other embodiments, the member comprises both a head contacting member and head engaging member. In yet still other embodiments, the head contacting member further comprises an adhesive to allow the visor to attach to the user by the adhesive itself, or to improve positioning by working in conjunction with the head engaging member.

Also provided herein is a process of making the face shields so as to avoid the present problems. The process also may be applied to produce 3-dimensional parts with varying angles along multiple axes while maintaining optical clarity of different uses, including but not limited to disposable glasses, potentially disposable camera optical protection, computer monitor or display covers, and any other applications where a thermoformed part requires a high level of optical performance.

### Visor

The following non limiting embodiments describe certain face shield designs. One embodiment provides a face shield comprising a visor that is curved about multiple axes, thereby providing far improved coverage and protection from patient generated airborne droplets. As a result of this change from a cylindrical shape to a three-dimensional shape with varying angles along multiple axes, the wearer's head is protected from the sides as well as the bottom, significantly enhancing operational safety and user comfort. Furthermore, the shape with varying angles along multiple axes allows better user comfort by allowing the wearer to move their head downwards to look directly at their bed-bound patient, without the risk of dislodging the mask simply by contact of the visor with their chest or neck. Moreover, the wearer has a better user experience in moving their heads from side to side, or reaching an arm across their body, such as to adjust a knob or pick up an item, without the risk of dislodging the mask.

In one embodiment, the face shield geometry is designed such that the flexibility in the visor material allows the face shield to conform to various users' head shapes, while utilizing the strength of the visor material to provide adequate structure and keep it sufficiently off the users' head.

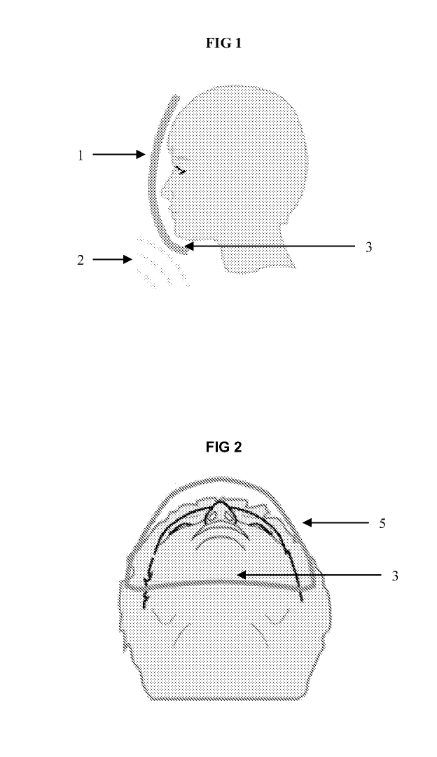

In certain embodiments, the face shield visor comprises two axes (e.g.; horizontal and vertical) to create the three-dimensional shape with varying angles along multiple axes. In certain embodiments, the visor comprises a smooth contour shape with a substantially uniform contour angle, such as a cylindrical shape. In certain other embodiments, the visor comprises varying contour angles for optimum coverage and fitting. FIGS. 1 and 2 provide perspective views of certain embodiments. In one embodiment, the visor comprises steeper contour angle of two axes points at the bottom of the visor near the chin portion (3) for improved protective coverage, while the top portion and center portion (1) is substantially flat thereby achieving optical clarity and the ability to look through the film and be able to see clearly through at a distance, for instance, in reading an eye chart from across a room, and side portions (5) are also minimally contoured by cylindrical shape. In certain embodiments, the side portions (5) are angled to act as side shields. In another embodiment, the substantially flat center portion of the visor is comprised of a cylindrical shape from bending a plastic film. In yet another embodiment, the steeper contour angle at the bottom of the face shield near the chin is made by a thermoforming process to obtain a 3-dimensional form with varying angles along multiple axes for improved coverage from hazardous substances particularly from below.

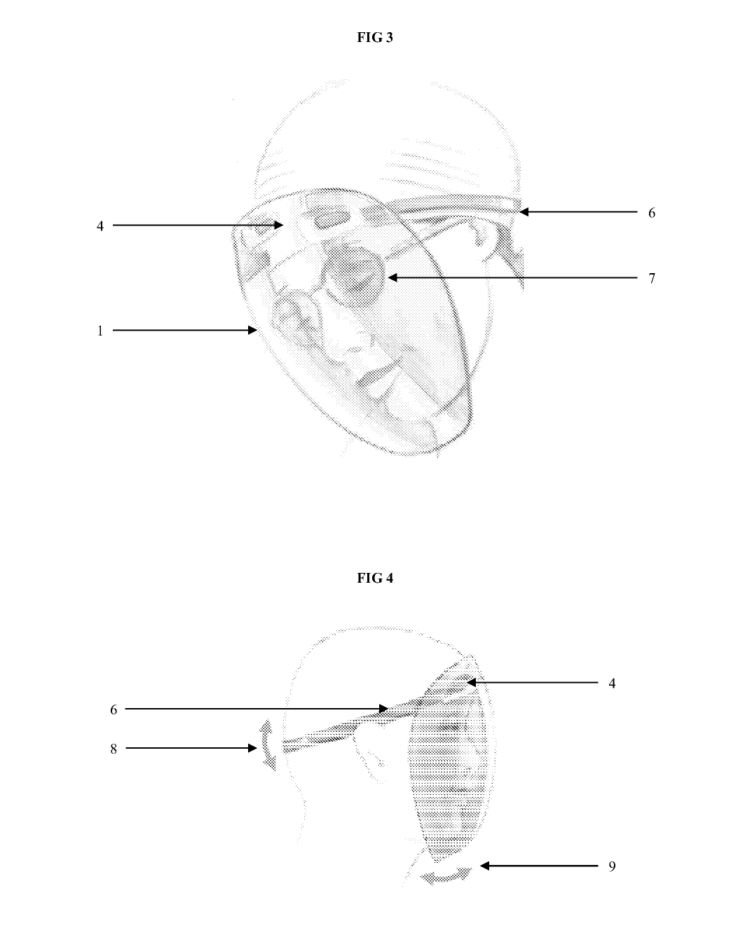

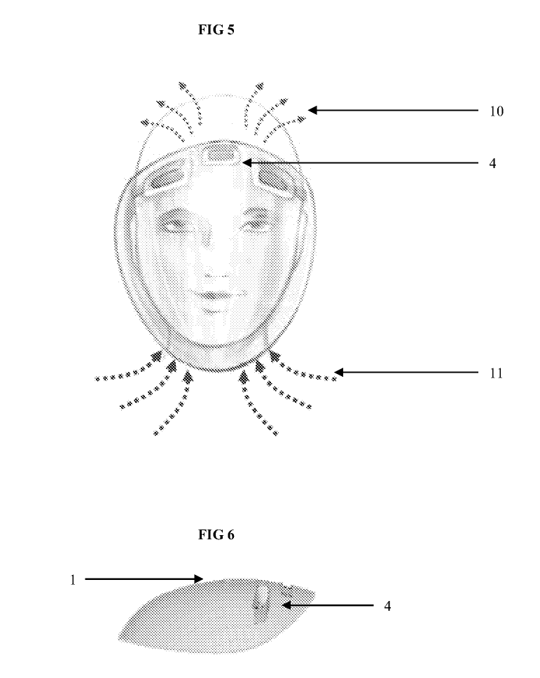

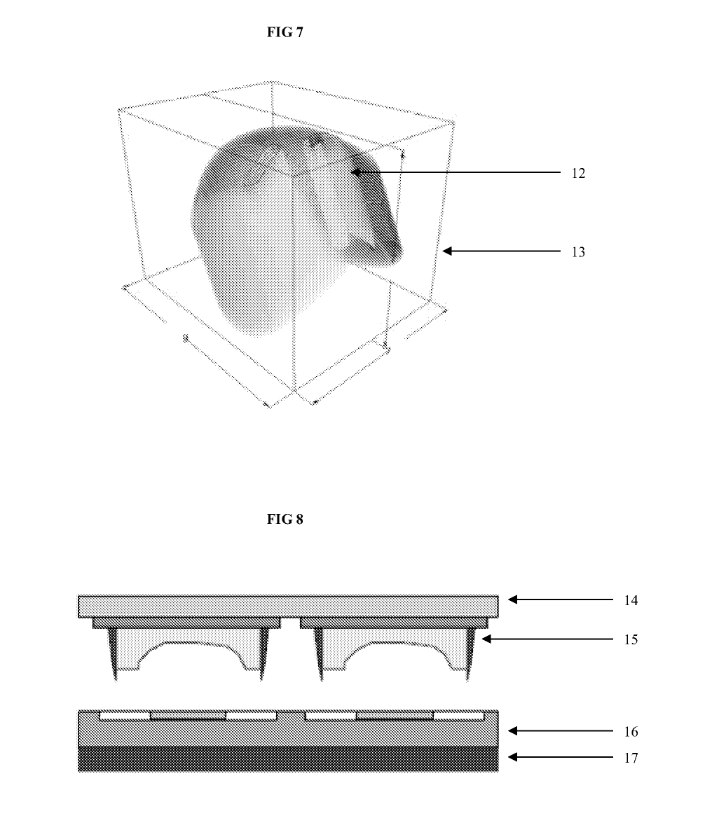

Furthermore, the face shield may be worn with or without various facial masks, glasses, goggles, varying hairstyles, and other user preferences as shown in FIG. 3 (7). Also, the face shields may be stacked efficiently as shown in FIG. 7 (12).

### Visor Material

In certain embodiments, the visor is formed of plastic material with excellent optical clarity and light weight. Acceptable plastic material in this embodiment includes, but is not limited to, PET, polycarbonate, polypropylene, OPS, BOP, PVC, polyester, acrylics, polystyrene, rigid vinyl (RPVC) polyester, polyethylene, clear acetate plastic, ABS, and other chemistries. In certain other embodiments, the visor is formed by other polymers with suitable optical clarity. In a preferred embodiment, the material is hypoallergenic.

In yet other embodiments, the visor material further comprises a chemical coating on the surface. In one embodiment, the coating comprises a scratch resistant coating. In another embodiment, the coating comprises a tint coating. In yet another embodiment, the coating comprises an anti-fogging coating. In yet still another embodiment, the coating comprises a stain-proof coating such as to avoid finger print attachment on the visor. In other embodiments, the plastic material embodies these features, such as scratch resistance, anti-fog, stain-proof, without a separate coating layer. In another embodiment, the coating comprises a UV light filtering or blocking coating.

### Head Contact

The face shield has a head contact area that secures the face shield and provides comfortable contact with the user. In one embodiment, the head contact area makes contact with the user's forehead. In certain other embodiments, the head contact area is in the shape of a protruding band. In yet other embodiments, the head contact area comprises a single protruding block. In yet still other embodiments, the head contact area comprises multiple protruding blocks.

The face shield according to one embodiment further allows for improved ventilation as shown in FIG. 5 (10) and (11), to minimize fogging of the face shield, thus improving user experience. In one embodiment, the face shield comprises a “tripod” head contact area (4) as shown in FIGS. 3, 4, and 5, which allows for ventilation space to be present between the face shield and contact area of the user. In this embodiment, the contact area of the user can be the forehead area of the user.

In these embodiments, head contact area can comprise a protrusion thermoformed by the visor material.

In another embodiment, the “tripod” head contact can comprise a separate material that is attached to the visor such as by adhesive, by mechanical attachment, or by other attachment such as laser or ultrasonic welding. In other embodiments, further ventilation is provided such as vents on the visor or the head contact area.

### Head Contact Material

In one embodiment, the head contact area comprises a three-dimensional protrusion created by deforming the visor material to create the head contact area out of the same material as the visor. In another embodiment, the head contact area comprises a separate cushion member such as a cushion material that is attached to the visor by adhesive, by mechanical attachment, or by other attachment such as laser or ultrasonic welding. Acceptable tripod material in this embodiment includes, but is not limited to, foam, gel pad, silicone, urethane, or other polymer or fabric with acceptable skin contact characteristics.

### Strap

The face mask further comprises an adjustable attachment member for positioning the face shield over the face of the wearer and adapted to adjust the angular position of the face shield relative to the face of the wearer. In certain embodiments, the strap locations on the back of the head and on the front of the head is adjustable, such that moving the strap to different places as shown in FIG. 4 (8) moves the face shield to different angular positions (9) relative to the face of the wearer. In one embodiment, the adjustable attachment member comprises a single elastic strap (6). In another embodiment, the elastic strap further comprises a fastener for strap length adjustment. In yet another embodiment, the strap is a non-elastic material with a fastener for strap length adjustment. In certain other embodiments, the adjustable attachment member comprises multiple straps, elastic or non-elastic and with or without a fastener, such as to allow increased adjustability of the face shield fitting. In still other embodiments, the adjustable attachment member is a head gear, such as a plastic ratchet adjustable head gear.

The adjustable attachment member can be fastened to the visor in many ways. In one embodiment, the strap is attached to the head contract area of the visor. In another embodiment, the strap is attached to the tripod head contact area (4). In yet another embodiment, the strap is attached to the outer surface of the visor. In certain other embodiments the strap is attached near the edge of the visor. Various methods of attaching the strap are available, such as by adhesive, by mechanical attachment such as passing the strap through holes in the visor, or by other attachment such as laser or ultrasonic welding.

Yet still in other embodiments, the adjustable attachment member comprises a pair of clips that engage the wearer's eyewear. The eyewear in these embodiments can be normal prescription glasses or safety glasses. In certain embodiments, the clips engage the eyewear bows. In other embodiments, the clips engage the eyewear frame. In yet other embodiments, the face shield comprises multiple clips that engage the frame and bow of the eyewear.

### Strap Material

In certain embodiments, the visor strap is formed of an elastic material. Acceptable elastic material in this embodiment includes, but is not limited to, polyisoprene, silicone, natural rubber, chloroprene, nylon, nitrile, polyacrylate, urethane, and styrene butadiene. In a preferred embodiment, the material is hypoallergenic. In a preferred embodiment, the elastic material is latex free.

### Manufacturing Method

Another embodiment further provides a manufacturing technique that allows a part to be manufactured using a thermoforming process while retaining the optical clarity of the original, pre-formed film of suitable material. Furthermore, embodiments are provided that are adaptable for high-speed economical thermoforming production. The following embodiments allow for very fine control over the exact shape and size of the area of optical clarity, allowing for fine design and manufacturing control.

In certain embodiments, the manufacturing method achieves an optically clear viewing surface in a part requiring 3-dimensional geometry with varying angles along multiple axes. In one embodiment, the viewing surface is manufactured by thermal film forming techniques. In this embodiment, the process of thermoforming comprises converting a flat film of plastic into a 3-dimensional part by heating the plastic beyond its forming temperature, then forming the part to its desired shape by draping the film into or onto a mold by gravity, pressure, vacuum, or other force. This 3-dimensional part forming achieves geometric features that enhance product function, such as bosses, ribs, and other 3-dimensional surfaces.

In certain embodiments, the thermoforming process involves heating a film only in areas where 3-dimensional formed geometry is desired, while not heating the film in areas where high optical clarity is desired, thereby selectively controlling the areas that may experience degradation of optical characteristics. In these embodiments, the film areas that are exposed to heat are readily thermoformable, and able to achieve 3-dimensional geometry with varying angles along multiple axes. The areas of film that are masked from heat are not truly thermoformable, because the film material has not become “stretchy” or pliable. These heat-masked “optical” areas are still able to be bent and curved to achieve surface geometries that do not involve stretching of the material, such as cylindrical sections or substantially flat sections, but cannot achieve surface geometry with varying angles along multiple axes that would require a fully plastic, elastic surface. In addition, this method may be used with many different types of thermal forming processes, such as vacuum-forming, pressure forming, combination vacuum/pressure forming, and other thermal film forming techniques.

### Vacuum-Forming

In one embodiment, the method comprises a vacuum-forming process, wherein a sheet of plastic film is located adjacent to a heating element, allowed to heat up to its forming temperature, at which point it becomes flexible. In this embodiment, the plastic film would be shielded from the heating elements in those select certain sections where optical clarity was desired. The sheet is then draped over a shaped mould, which incorporates a vacuum, drawing the flexible plastic sheet down onto the mould, taking its shape. Once the film cools, it regains its rigidity, only now having the form of the mould. In this embodiment, the heat mask may be made of any number of different insulation materials including, but not limited to, insulating ceramic, mineral fiber, tool-makers insulation board, Teflon, and thermal insulation sheet. In certain embodiments the heat mask is a “passive” heat mask, such that the heat mask functions based on the thermal conductivity of the mask itself, such as a piece of shaped insulation material. In certain other embodiments the heat mask is an “active” heat mask, such that the heat mask is actively cooled by, for instance, water or coolant circulating through it, or even by other cooling such as solid state chillers, fans, or the like.

### Pressure-Forming

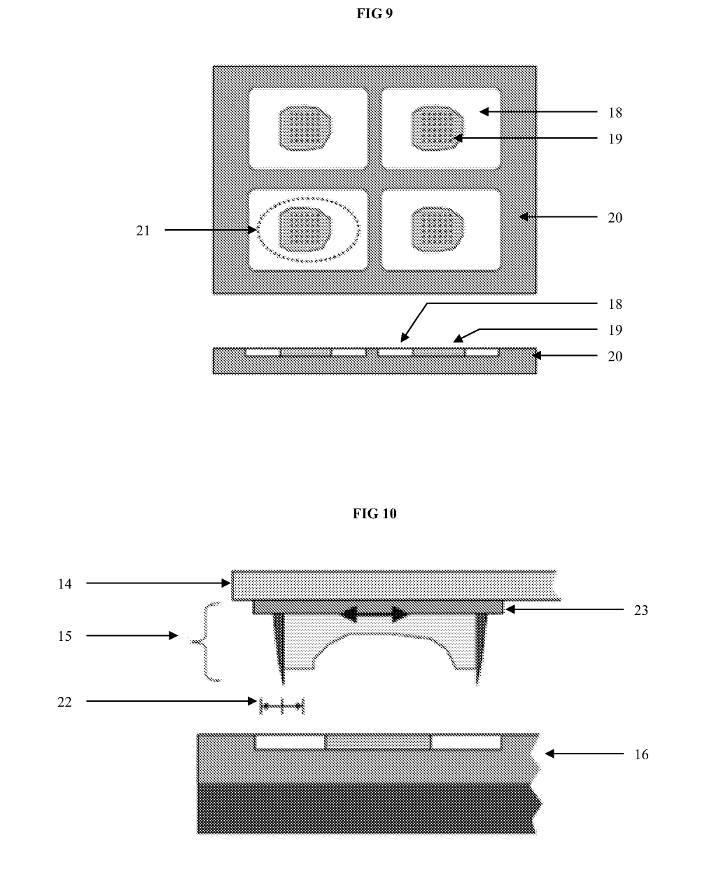

In another embodiment, the method comprises a pressure-forming process, wherein a sheet of plastic film is brought into contact with a “hot plate”, whereupon the plastic film quickly rises to its forming temperature. When the plastic film reaches the forming temperature, air is blown such as through perforations in the hot plate, pressurizing the film and pressing it against a mould positioned directly in line with the plastic film, where it rapidly cools and hardens to its new shape. In this embodiment, the hot plate may be modified to incorporate the heat mask in a number of different ways. In one embodiment, the heat mask is incorporated by applying an insulation material directly onto the hot plate, using any number of attachments such as mechanical, magnetic, or adhesive. In a preferred embodiment, as shown in FIG. 8 through 10, the heat mask comprises a customized hotplate (16), where there is an insulator (19) and strike plate (18) for the cutting area (21) embedded right into the hot plate surface (20), shaped to the exact area of desired optical clarity, thereby achieving more consistent and efficient manufacturing, especially when thermoforming on a continuous web at high speeds. The custom hotplate (16) is then connected to the heating surface (17). The insulation material suitable for heat masking includes, but is not limited to, insulating ceramic, mineral fiber, tool-makers insulation board, Teflon, and DME thermal insulation sheet. The tooling used for this method may further comprise mould and die sets (15) connected to a cavity plate (23), which in turn is mounted to a steel mounting plate (14), wherein the mounting is via slots which allows position adjustment along 1 axis (22).

The heat mask may take the form of a “passive” or “active” heat mask. In a “passive” embodiment, the heat mask area may be passively cooled, such as by ambient air or the heat-draw of the plastic film itself. In an “active” embodiment, the heat mask area may be actively cooled, by water-cooling, air-cooling, solid-state cooling, fans, and the like. In yet another embodiment, the heat mask is made from the same piece of material as the hot-plate. In one embodiment, the hot plate is aluminum based, wherein the heat masked area comprises aluminum that is not in contact with the overall heating elements, thereby creating cooler portions of the hot-plate. In this embodiment, the coolness may be regulated by controlling variables such as material thickness in the heat-mask portion or the amount and temperature of air blowing through holes in the heat-mask area, as well as other “passive” and “active” cooling approaches, as previously listed. In other embodiments, the tools can be made from epoxy, wood, structural foam, and steel.

In general, this method may be applied to production processes that occur at a wide range of speeds, such as one-at-a-time production, all the way through to high-speed, automated, in-line thermoforming machinery using high cavitation moulds.

In certain embodiments, the manufacturing method described above is used to produce plastic parts that are a combination of thermoformed areas with varying angles along multiple axes and non-thermoformed areas with a substantially flat or cylindrical shape. In other embodiments, said method can be used to produce glass parts that are thermoformed into a combination of 3 dimensional features shape with varying angles along multiple axes and substantially flat or cylindrical shapes. These parts made of plastic or glass can be used in various applications. In one embodiment, the plastic or glass part thermoformed by the method is a face shield. In another embodiment, the plastic or glass part thermoformed by the method is a window. In yet another embodiment, the plastic or glass part thermoformed by the method is a disposable camera optical protection. In yet still another embodiment, the plastic or glass part thermoformed by the method is a computer monitor or display cover. In other embodiments, the method can be used to make various parts where a thermoformed part requires a high level of optical performance.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A face shield comprising:
(a) a contoured visor having a 3-dimensional shape portion with varying angles along multiple axes that protects a user's face from the front, bottom and sides, thereby achieving improved operational safety and user comfort, while retaining optical clarity, and
(b) a head contact member.

2. The face shield of claim 1, wherein said face shield is made of a material comprising hypoallergenic and latex free materials.

3. The face shield of claim 1, wherein said head contact area comprises a 3-dimensional protrusion created by deforming said visor to create a tripod protrusion.

4. The face shield of claim 1, wherein said head contact area comprises a cushion member connected to said visor by an attachment member.

5. The face shield of claim 1, wherein said face shield further comprises an adjustable attachment member that allows easy visor angle and position adjustment by the user.

6. The face shield of claim 5, wherein said adjustable attachment member comprises a single elastic head strap.

7. The face shield of claim 6, wherein said single elastic head strap further comprises a fastener or coupling member for strap length adjustment.

8. The face shield of claim 5, wherein said adjustable attachment member comprises two head straps with fasteners or coupling members for strap length adjustment.

9. The face shield of claim 5, wherein said adjustable attachment member comprises an adjustable ratchet headgear.

10. The face shield of claim 1, wherein said visor has two axes points, horizontal and vertical, to achieve improved coverage and protection.

11. The face shield of claim 10, wherein said visor comprises a smooth contour shape with a substantially uniform curvature angle.

12. The face shield of claim 10, wherein said visor comprises a varying contour angle for optimum coverage and fitting.

13. The face shield of claim 12, wherein said visor comprises a steeper contour angle of two axes points near the chin portion for protective coverage, while the center portion is substantially flat, and side portions which are only minimally contoured in two axes points.

14. The face shield of claim 1, wherein said visor comprises thin plastic material with improved optical clarity and light weight compared to conventional face shields.

15. The face shield as claimed in any of the preceding claims, wherein said visor further comprises a single or multiple coatings on the surface, selected from the group comprising of scratch resistant coating, tint coating, anti-fog coating, anti-glare coating, anti-reflection coating, stain-proof coating, and UV light filtering or blocking coating.

16. A single piece face shield comprising:
(a) a visor having a 3-dimensional feature with varying angles along multiple axes that provides protection from the sides as well as the bottom of a user's head, significantly enhancing operational safety and user comfort,
(b) a visor geometry based on flexibility in plastic material forming said visor to allowing the visor to conform to various users' head shapes, while utilizing the strength of the visor's plastic material to provide adequate structure as the visor is kept sufficiently off the users' head,
(c) a head contact area for improved ventilation, and
(d) an adjustable attachment member securing the visor to the user's head that allows easy visor angle and position adjustment by the user.

17.-30. (canceled)

31. A method of producing a 3-dimensional plastic part with varying angles along multiple axes and improved optical clarity, comprising:
(a) thermoforming by heating a plastic film to its forming temperature only in areas where 3-dimensional formed geometry is desired and not heating portions of said plastic film that are desired to retain optical clarity,
(b) forming said selectively heated plastic film into the desired shape using a mould, and
(c) cooling said plastic film in the mould to harden said film to its desired shape.

32. The method of claim 31, wherein said method comprises the use of one or more heat masking elements.

33. The method of claim 31, wherein said method comprises:
i) vacuum-forming, wherein said sheet of plastic film is located adjacent to a heating element to heat up to the forming temperature of the plastic film, while the heat mask is employed on portions desired to retain optical clarity,
(ii) followed by said heated film being draped over a shaped mould, wherein said shaped mould incorporates a vacuum, drawing the flexible plastic sheet down onto the mould, and
(iii) cooling said plastic film in the mould to harden to its desired shape.

34. The method of claim 32, wherein said method comprises:
(i) pressure-forming, wherein said sheet of plastic film is brought into contact with a “hot plate”, whereupon the plastic film rises to its forming temperature, while said one or more heat masking elements are employed on portions desired to retain optical clarity,
(ii) followed by air blown to pressurize the film and press it against a mould positioned directly in line with the plastic film, and
(iii) cooling said plastic film in the mould to harden to its desired shape.

35.-70. (canceled)

71. An apparatus for forming a plastic film comprising:
(a) a heating element, and
(b) a mechanism to prevent or reduce heating in select certain sections where optical clarity is desired.

72.-79. (canceled)

80. A protective face shield comprising:
(a) a cylindrical-shaped body member,
(b) a forehead-engaging rearward member, and
(c) a three dimensional feature with varying angles along multiple axes at the bottom of the face shield, thereby improving operational safety and user comfort.

81.-102. (canceled)
